(19) United States
(12) Patent Application Publication
(10) Pub. No.: US 2024/0092315 A1
(43) Pub. Date: Mar. 21, 2024

(54) WIPER BLADE LIFTING MECHANISM

(71) Applicant: GM Cruise Holdings LLC, San Francisco, CA (US)

(72) Inventor: Nathaniel Barrett Herse, San Francisco, CA (US)

(21) Appl. No.: 17/945,947

(22) Filed: Sep. 15, 2022

(51) Int. Cl. B60S 1/34; B60S 1/08

(52) U.S. Cl. CPC B60S 1/3413; B60S 1/08; B60S 1/3495

(57) ABSTRACT

The disclosed technology provides solutions for improving window wiper systems and in particular, for improving wiper systems used on autonomous vehicles (AVs). Aspects of the disclosed technology include a widow wiper system that includes a motor comprising a shaft, a wiper arm coupled to a distal end of the shaft, and a wiper guide disposed around the distal end of the shaft, wherein the wiper guide comprises a guidance track that is configured to accommodate a protrusion of the wiper arm through a side surface of the wiper guide. Autonomous vehicle systems and methods of manufacture are also provided.

### BACKGROUND

### 1. Technical Field

The disclosed technology provides solutions for improving automotive window wiper systems and in particular, for improving windshield wiper systems for autonomous vehicles (AVs).

### 2. Introduction

Autonomous vehicles (AVs) are vehicles having computers and control systems that perform driving and navigation tasks that are conventionally performed by a human driver. As AV technologies continue to advance, they will be increasingly used to improve transportation efficiency and safety. As such, AVs will need to perform many of the functions that are conventionally performed by human drivers, such as performing navigation and routing tasks necessary to provide a safe and efficient transportation. Such tasks may require the collection and processing of large quantities of data using various sensor types, including but not limited to cameras and/or Light Detection and Ranging (LiDAR) sensors disposed on the AV. In some instances, the collected data can be used by the AV to perform tasks relating to routing, planning and obstacle avoidance.

### BRIEF DESCRIPTION OF THE DRAWINGS

Certain features of the subject technology are set forth in the appended claims. However, the accompanying drawings, which are included to provide further understanding, illustrate disclosed aspects and together with the description serve to explain the principles of the subject technology. In the drawings:

FIG. 1 illustrates an example of an autonomous vehicle (AV) platform, as well as applications and a data center that can be used to facilitate AV dispatch and operations, according to some aspects of the disclosed technology.

FIG. 2 illustrates an example of a wiper system including a cylindrical wiper guide, according to some aspects of the disclosed technology.

FIG. 3 illustrates a cut-away perspective view of a wiper guide, including a guidance track, according to some aspects of the disclosed technology.

FIG. 4 illustrates a side-view of a wiper guide, including a one-sided guidance track, according to some aspects of the disclosed technology.

FIG. 5 illustrates an example method for assembling or manufacturing a wiper system, according to some aspects of the disclosed technology.

FIG. 6 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring certain concepts.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Windshield wiper systems are commonly used on various vehicle platforms. Wiper blades, which typically rely on rubber flexures, can become worn and brittle when stored for long durations while pressed against a wiping surface, such as a glass surface of a vehicle window. Over time, the wiper blades can become brittle and deformed, making it difficult or impossible for the blade to flip when changing directions while wiping is performed, resulting in “chisel chatter.”

One way to prevent wear on wiper blades is to ensure that the blade is lifted from the wiping surface (e.g., the window or windshield) before operation is stopped and the wiper is parked. In conventional vehicle systems, wiper blade lifting is commonly facilitated using a ramp or other inclining device that is separate and detached from the wiper assembly.

Aspects of the disclosed technology provide wiper blade lifting solutions that include a wiper assembly with an integrated wiper guide and guidance track. The wiper assembly (or window wiping system) of the disclosed technology can be deployed on vehicles, such as autonomous vehicles (AVs). However, it is understood that the wiping system disclosed herein may be deployed on vehicles of other types, and/or used for other purposes, without departing from the scope of the disclosed technology.

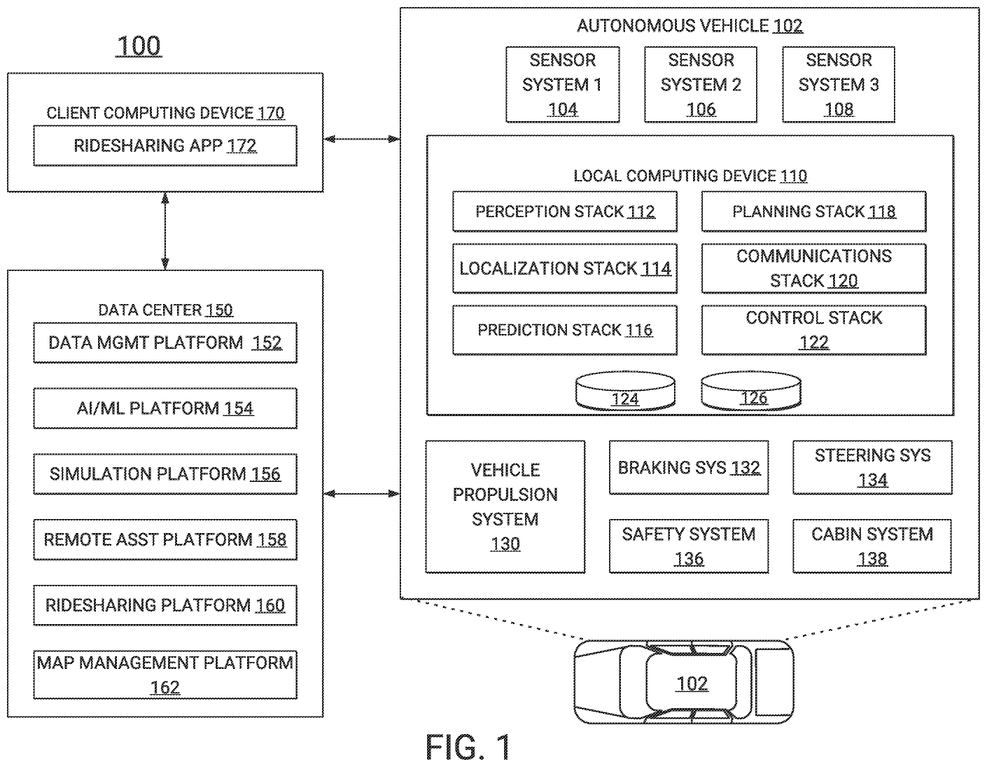

FIG. 1 illustrates an example of an AV management system 100. One of ordinary skill in the art will understand that, for the AV management system 100 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

AV 102 can navigate roadways without a human driver based on sensor signals generated by multiple sensor systems 104, 106, and 108. The sensor systems 104-108 can include different types of sensors and can be arranged about the AV 102. For instance, the sensor systems 104-108 can comprise Inertial Measurement Units (IMUs), cameras (e.g., still image cameras, video cameras, etc.), optical sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other embodiments may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some embodiments, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can additionally include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a mapping and localization stack 114, a prediction stack 116, a planning stack 118, a communications stack 120, a control stack 122, an AV operational database 124, and an HD geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can also identify environmental uncertainties, such as where to look for moving objects, flag areas that may be obscured or blocked from view, and so forth. In some embodiments, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

Mapping and localization stack 114 can determine the AV's position and orientation (pose) using different methods from multiple systems (e.g., GPS, IMUs, cameras, LIDAR, RADAR, ultrasonic sensors, the HD geospatial database 126, etc.). For example, in some embodiments, AV 102 can compare sensor data captured in real-time by sensor systems 104-108 to data in HD geospatial database 126 to determine its precise (e.g., accurate to the order of a few centimeters or less) position and orientation. AV 102 can focus its search based on sensor data from one or more first sensor systems (e.g., GPS) by matching sensor data from one or more second sensor systems (e.g., LIDAR). If the mapping and localization information from one system is unavailable, AV 102 can use mapping and localization information from a redundant system and/or from remote data sources.

Prediction stack 116 can receive information from localization stack 114 and objects identified by perception stack 112 and predict a future path for the objects. In some embodiments, prediction stack 116 can output several likely paths that an object is predicted to take along with a probability associated with each path. For each predicted path, prediction stack 116 can also output a range of points along the path corresponding to a predicted location of the object along the path at future time intervals along with an expected error value for each of the points that indicates a probabilistic deviation from that point.

Planning stack 118 can determine how to maneuver or operate AV 102 safely and efficiently in its environment. For example, planning stack 118 can receive the location, speed, and direction of AV 102, geospatial data, data regarding objects sharing the road with AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. Planning stack 118 can determine multiple sets of one or more mechanical operations that AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct AV 102 to go around the block instead of blocking a current lane while waiting for an opening to change lanes.

Control stack 122 can manage the operation of the vehicle propulsion system 130, the braking system 132, the steering system 134, the safety system 136, and the cabin system 138. Control stack 122 can receive sensor signals from the sensor systems 104-108 as well as communicate with other stacks or components of the local computing device 110 or a remote system (e.g., the data center 150) to effectuate operation of AV 102. For example, control stack 122 can implement the final path or actions from the multiple paths or actions provided by planning stack 118. This can involve turning the routes and decisions from planning stack 118 into commands for the actuators that control the AV's steering, throttle, brake, and drive unit.

Communications stack 120 can transmit and receive signals between the various stacks and other components of AV 102 and between AV 102, data center 150, client computing device 170, and other remote systems. Communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). Communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

HD geospatial database 126 can store HD maps and related data of the streets upon which the AV 102 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

AV operational database 124 can store raw AV data generated by the sensor systems 104-108, stacks 112-122, and other components of AV 102 and/or data received by AV 102 from remote systems (e.g., data center 150, client computing device 170, etc.). In some embodiments, the raw AV data can include HD LIDAR point cloud data, image data, RADAR data, GPS data, and other sensor data that data center 150 can use for creating or updating AV geospatial data or for creating simulations of situations encountered by AV 102 for future testing or training of various machine learning algorithms that are incorporated in local computing device 110.

Data center 150 can be a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and so forth. Data center 150 can include one or more computing devices remote to local computing device 110 for managing a fleet of AVs and AV-related services. For example, in addition to managing AV 102, data center 150 may also support a ridesharing service, a delivery service, a remote/roadside assistance service, street services (e.g., street mapping, street patrol, street cleaning, street metering, parking reservation, etc.), and the like.

Data center 150 can send and receive various signals to and from AV 102 and client computing device 170. These signals can include sensor data captured by the sensor systems 104-108, roadside assistance requests, software updates, ridesharing pick-up and drop-off instructions, and so forth. In this example, data center 150 includes a data management platform 152, an Artificial Intelligence/Machine Learning (AI/ML) platform 154, a simulation platform 156, a remote assistance platform 158, and a ridesharing platform 160, and a map management platform 162, among other systems.

Data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structured (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 150 can access data stored by the data management platform 152 to provide their respective services.

AI/ML platform 154 can provide the infrastructure for training and evaluating machine learning algorithms for operating AV 102, the simulation platform 156, the remote assistance platform 158, the ridesharing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

Simulation platform 156 can enable testing and validation of the algorithms, machine learning models, neural networks, and other development efforts for AV 102, remote assistance platform 158, ridesharing platform 160, map management platform 162, and other platforms and systems. The simulation platform 156 can replicate a variety of driving environments and/or reproduce real-world scenarios from data captured by AV 102, including rendering geospatial information and road infrastructure (e.g., streets, lanes, crosswalks, traffic lights, stop signs, etc.) obtained from a cartography platform (e.g., map management platform 162); modeling the behavior of other vehicles, bicycles, pedestrians, and other dynamic elements; simulating inclement weather conditions, different traffic scenarios; and so on.

Remote assistance platform 158 can generate and transmit instructions regarding the operation of the AV 102. For example, in response to an output of the AI/ML platform 154 or other system of data center 150, remote assistance platform 158 can prepare instructions for one or more stacks or other components of AV 102.

Ridesharing platform 160 can interact with a customer of a ridesharing service via a ridesharing application 172 executing on client computing device 170. The client computing device 170 can be any type of computing system, including a server, desktop computer, laptop, tablet, smartphone, smart wearable device (e.g., smartwatch, smart eyeglasses or other Head-Mounted Display (HMD), smart ear pods, or other smart in-ear, on-ear, or over-ear device, etc.), gaming system, or other general purpose computing device for accessing ridesharing application 172. Client computing device 170 can be a customer's mobile computing device or a computing device integrated with the AV 102 (e.g., the local computing device 110). The ridesharing platform 160 can receive requests to pick up or drop off from the ridesharing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs 102, Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some embodiments, the map viewing services of map management platform 162 can be modularized and deployed as part of one or more of the platforms and systems of data center 150. For example, the AI/ML platform 154 may incorporate the map viewing services for visualizing the effectiveness of various object detection or object classification models, simulation platform 156 may incorporate the map viewing services for recreating and visualizing certain driving scenarios, remote assistance platform 158 may incorporate the map viewing services for replaying traffic incidents to facilitate and coordinate aid, ridesharing platform 160 may incorporate the map viewing services into client application 172 to enable passengers to view AV 102 in transit en route to a pick-up or drop-off location, and so on.

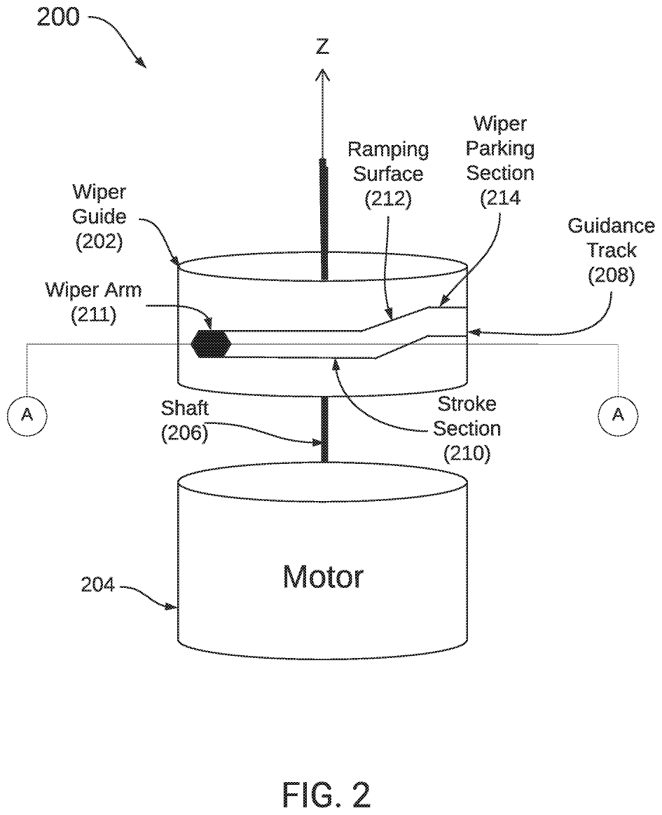

FIG. 2 illustrates an example of a wiper system 200. Wiper system 200 includes a wiper guide 202 that is disposed around a shaft 206 of motor 204, such that shaft 206 may freely rotate within wiper guide 202. Wiper guide 202 includes a (two-sided) guidance track 208 configured to permit protrusion of a wiper arm 211 in an outward/normal direction with respect to a side-surface of wiper guide 202.

In operation, wiper guide 202 is configured to guide the movement of wiper arm 211 and, to elevate wiper arm 211, e.g., once wiping operations have ended and wiper arm 211 is placed in a parked position.

During wiping operation, wiper arm 211 can be actuated by motor 204, via shaft 206, in a back-forth motion within stroke section 210 of guidance track 208. Once wiping has ended and wiper arm 211 is to be parked, wiper arm 211 can be actuated over ramping surface 212 into parking section 214. While traversing ramping surface 212, wiper arm 211 is elevated (along the z-axis) with respect to wiper guide 202, thereby lifting a corresponding wiper blade from a wiping surface (not illustrated).

Wiping system operation may be improved by reducing frictional forces incident on wiper arm 211. To this end, one or more surfaces of wiper arm 211 and/or guidance track 208 may be configured to reduce friction at any contact interface. For example, guidance track 208 and/or wiper arm 211 may include, or may be made from, low friction materials, including but not limited to: steel, brass, ultra-high-molecular weight polyethylene (UHMWPE), or the like. Additionally, surfaces of guidance track 208 may be prepared with or without lubrication, such as oil, or an oil mixture impregnated with bronze, for example.

In some configurations, mechanical elements may be used to reduce friction between guidance track 208 and wiper arm 211. By way of example, the use of a rolling element integrated with wiper arm 211 may reduce friction with guidance track 208.

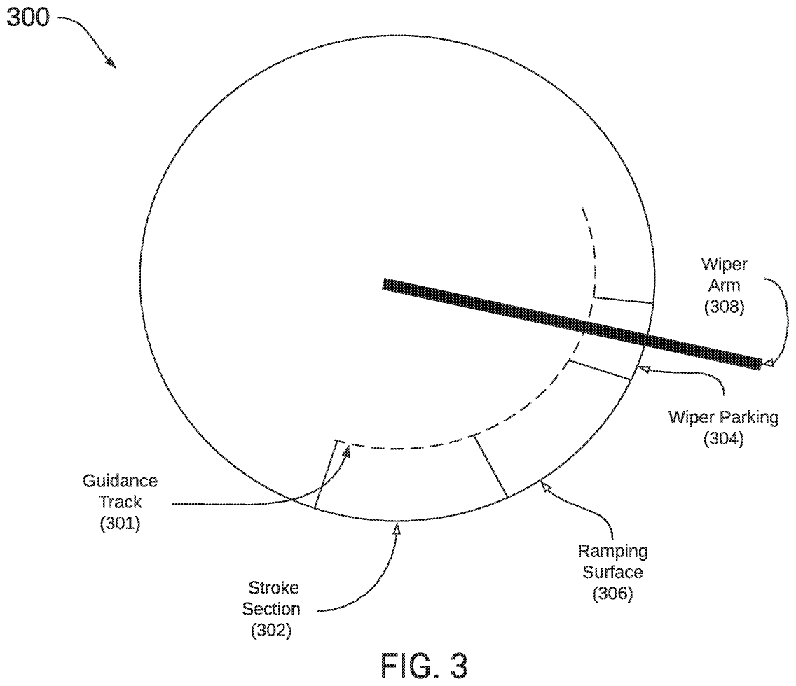

FIG. 3 further illustrates a cut-away view of wiper guide 202, further illustrating the stroke section, ramping surface, and wiper parking section.

Specifically, FIG. 3 illustrates a cut-away perspective view of an example wiper guide 300. Wiper guide 300 includes a guidance track 301 having a stroke section 302, and a parking section 304 that are connected via a ramping surface 304. As discussed above, wiper stroke section 302 can include a portion of the guidance track 301 that is at an even elevation (e.g., a first height) with respect to the z-axis (e.g., FIG. 2), whereas wiper parking section 304 can be disposed above the wiper stroke section 302 (e.g., at a second height) with respect to the upright wiper guide orientation illustrated by FIG. 2. Ramping surface 306 can be configured to lift or raise a wiper arm 308 as it is actuated from wiper stroke section 302, into the wiper parking section 304. In the example of FIG. 3, wiper arm 308 is in a parked position (e.g., in wiper parking section 304), such that a wiper blade (not illustrated) of wiper arm 308 is lifted from and/or above a wiping surface (not illustrated).

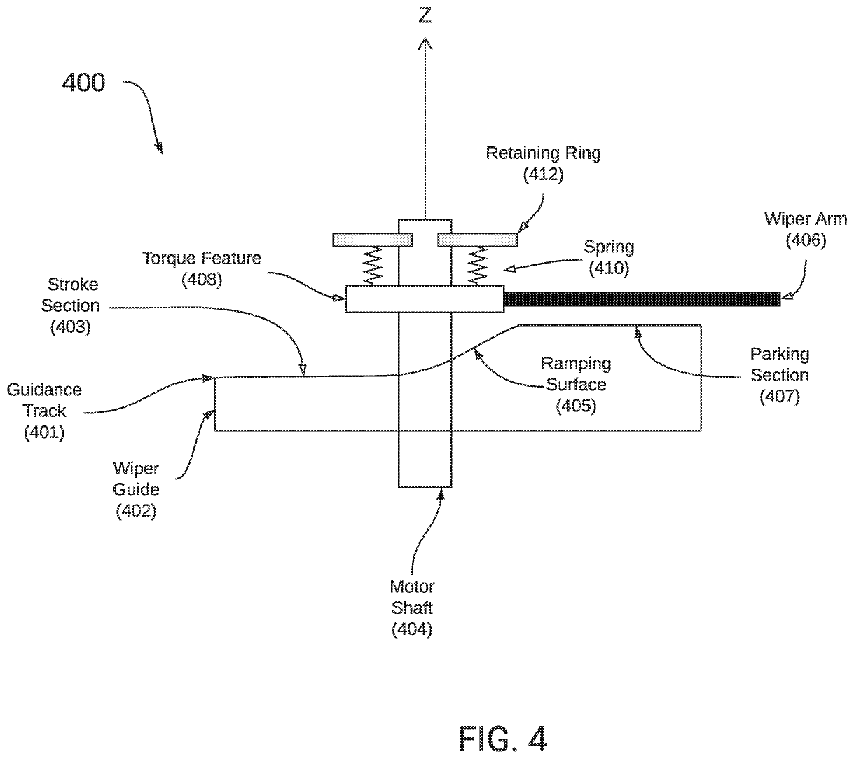

FIG. 4 illustrates a side-view of a window wiping system 400, including a one-sided guidance track 401 provided by a surface of wiper guide 402. Guidance track 401 includes a stroke section 403, a ramping surface 405, and a parking section 407. In operation, wiper guide 402 is disposed around a motor shaft 404, e.g., such that motor shaft 404 may freely rotate within wiper guide 402. When wiping is performed using wiper arm 406, wiper arm 406 can be actuated within stroke section 403, e.g., at a first height with respect to wiper guide 402. When wiping operations are stopped, torque exerted by motor shaft 404 can be used to re-position wiper arm 406 onto parking section 407, e.g., at a second height with respect to wiper guide 402. Notably, the second height provided by the elevation/placement of parking section 407 is higher (with respect to the z-axis) than the first height provided by the elevation/placement of guidance track 401. That is, ramping surface 405 of wiper guide 402 is configured to raise wiper arm 406 from the first height at stroke section 403, to the second height, at parking section 407. By elevating wiper arm 406 (at the second height provided by parking section 407), a wiper blade (not illustrated) associated with wiper arm 406 can be suspended above the wiping surface (not illustrated), e.g., in a parked position.

Translation of wiper arm 406, along the z-axis, with respect to motor shaft 404, is facilitated by torque feature 408, which permits z-axis movement of wiper arm 406 while retaining a rotational force around/about the z-axis. Torque feature 408 can be a slip-fitting; however, it is understood that alternative attachment devices may be used in place of torque feature 408, without departing from the scope of the disclosed technology.

In some configurations, a spring 410 can be attached between a retaining ring 412 and torque feature 408, e.g., to exert a force onto wiper arm 406 such that wiper arm 406 maintains contact with guidance track 401. In some aspects, a tension of the spring 410 can be selected/configured such that spring 410 imparts an optimal preload force onto wiper arm 406, for example, to maintain contact between a wiper blade and a wiping surface (not illustrated).

In some aspects, spring 410 may be a compression spring that is coaxial to the motor shaft. Spring 410 may be configured to permit a lifting/displacement of wiper arm 406, for example, to facilitate a changing of an attached wiper blade (not illustrated). As such, spring 410 may be used as a replacement for the extension spring and pivot-joint wiper configurations that are used in many conventional wiper setups.

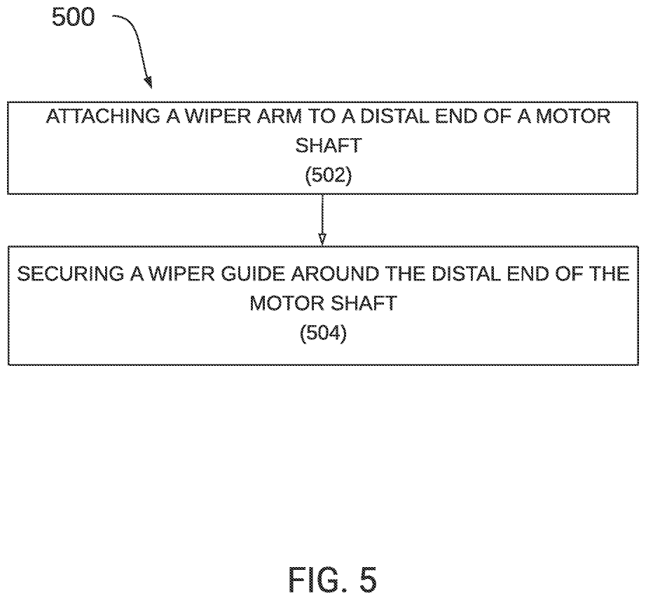

FIG. 5 illustrates an example method 500 for assembling or manufacturing a wiper system, according to some aspects of the disclosed technology.

At step 502, the process 500 includes attaching a wiper arm to a distal end of a motor shaft. As discussed above, attachment of the wiper arm may be facilitated using a torque feature (such as torque feature 408), which permits movement/translation of the wiper arm along the motor shaft, while still permitting rotation of the wiper arm about the motor shaft. In some aspects, the wiper arm may be held in position against a wiping surface, e.g., by a spring that is disposed between a retaining ring located at a distal end of the motor shaft, and that is configured to impart a force against the wiper arm, e.g., as illustrated in FIG. 4.

At step 504, the process 500 includes securing a wiper guide around the distal end of the motor shaft, wherein the wiper guide comprises a guidance track configured to accommodate a protrusion of the wiper arm through a side surface of the wiper guide. Depending on the desired implementation, the wiper guide may be two-sided, as illustrated in the example of FIG. 2; alternatively, the wiper guide may be one-sided, as illustrated in the example of FIG. 4. As discussed above, various surfaces of the wiper arm and/or wiper guide (e.g., the guidance track) may be configured to reduce friction and to permit motion of the wiper arm within the wiper guide. For example, the guidance track and/or wiper arm may include, or may be made from, low friction materials, including but not limited to steel, brass, ultra-high-molecular weight polyethylene (UHMWPE), or the like. Additionally, surfaces of the guidance track may be prepared with or without lubrication, such as oil, or an oil mixture impregnated with bronze, etc.

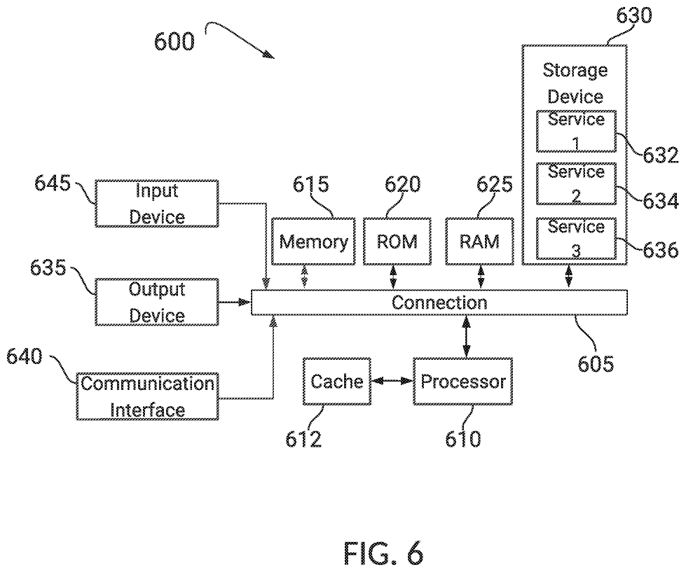

FIG. 6 illustrates an example apparatus (e.g., a processor-based system) with which some aspects of the subject technology can be implemented. For example, processor-based system 600 can be any computing device making up internal computing system 110, remote computing system 150, a passenger device executing the rideshare app 170, or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

Computing system 600 can be (or may include) a distributed system in which the functions described in this disclosure can be distributed within a datacenter, multiple data centers, a peer network, etc. In some embodiments, one or more of the described system components represents many such components each performing some or all of the functions for which the component is described. In some embodiments, the components can be physical or virtual devices.

Example system 600 includes at least one processing unit (CPU or processor) 610 and connection 605 that couples various system components including system memory 615, such as read-only memory (ROM) 620 and random-access memory (RAM) 625 to processor 610. Computing system 600 can include a cache of high-speed memory 612 connected directly with, in close proximity to, or integrated as part of processor 610.

Processor 610 can include any general-purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of several output mechanisms known to those of skill in the art. In some instances, multimodal systems can enable a user to provide multiple types of input/output to communicate with computing system 600. Computing system 600 can include communications interface 640, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communication interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a Blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L6), resistive random-access memory (RRAM/ReRAM), phase change memory (PCM), spin transfer torque RAM (STT-RAM), another memory chip or cartridge, and/or a combination thereof.

Storage device 630 can include software services, servers, services, etc., that when the code that defines such software is executed by the processor 610, it causes the system to perform a function. In some embodiments, a hardware service that performs a particular function can include the software component stored in a computer-readable medium in connection with the necessary hardware components, such as processor 610, connection 605, output device 635, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

1. A window wiping system, comprising:
a motor comprising a shaft;
a wiper arm coupled to a distal end of the shaft and being perpendicular to the shaft; and
a wiper guide disposed around the distal end of the shaft, wherein the wiper guide comprises a guidance track that is configured to accommodate a protrusion of the wiper arm through a side surface of the wiper guide while the protrusion and the wiper arm rotate around an axis of the shaft.

2. The window wiping system of claim 1, wherein the guidance track comprises a ramping surface that is configured to elevate the wiper arm within the guidance track.

3. The window wiping system of claim 1, further comprising:
a spring disposed within the wiper guide, wherein the spring is configured to hold the wiper arm to a bottom side of the guidance track.

4. The window wiping system of claim 1, wherein the wiper arm is coupled to the distal end of the shaft using a slip-fitting.

5. The window wiping system of claim 1, wherein the guidance track is a one-sided track.

6. The window wiping system of claim 1, wherein the guidance track is a two-sided track.

7. The window wiping system of claim 1, wherein the guidance track comprises a stroke section disposed at a first height with respect to the wiper guide.

8. The window wiping system of claim 7, wherein the guidance track comprises a parking section, the parking section disposed at a second height with respect to the wiper guide, and wherein the parking section is above the stroke section.

9. An autonomous vehicle (AV) comprising:
at least one window; and
a wiper system configured to clean the at least one window, the wiper system comprising:
a motor comprising a shaft;
a wiper arm coupled to a distal end of the shaft and being perpendicular to the shaft;
a wiper blade coupled to a distal end of the wiper arm; and
a wiper guide disposed around the distal end of the shaft, wherein the wiper guide comprises a guidance track that is configured to accommodate the wiper blade of the wiper arm through a side surface of the wiper guide while the wiper blade and the wiper arm rotate around an axis of the shaft.

10. The AV of claim 9, wherein the guidance track comprises a ramping surface that is configured to elevate the wiper arm within the guidance track.

11. The AV of claim 9, wherein the wiper system further comprises:
a spring disposed within the wiper guide, wherein the spring is configured to hold the wiper arm to a bottom side of the guidance track.

12. The AV of claim 9, wherein the wiper arm is coupled to the distal end of the shaft using a slip-fitting.

13. The AV of claim 9, wherein the guidance track is a one-sided track.

14. The AV of claim 9, wherein the guidance track is a two-sided track.

15. The AV of claim 9, wherein the guidance track comprises a stroke section disposed at a first height with respect to the wiper guide.

16. The AV of claim 15, wherein the guidance track comprises a wiper parking section, the wiper parking section disposed at a second height with respect to the wiper guide, and wherein the wiper parking section is above the stroke section.

17. A method of manufacturing a window wiping system, comprising:
attaching in perpendicular a wiper arm to a distal end of a motor shaft; and
securing a wiper guide around the distal end of the motor shaft, wherein the wiper guide comprises a guidance track that is configured to accommodate a protrusion of the wiper arm through a side surface of the wiper guide while the protrusion and the wiper arm rotate around an axis of the motor shaft.

18. The method of claim 17, wherein the guidance track comprises a ramping surface that is configured to elevate the wiper arm within the guidance track.

19. The method of claim 17, further comprising:
disposing a spring within the wiper guide, wherein the spring is configured to hold the wiper arm to a bottom side of the guidance track.

20. The method of claim 17 wherein the wiper arm is coupled to the distal end of the motor shaft using a slip-fitting.
